(19) United States
(12) Patent Application Publication
(10) Pub. No.: US 2016/0142633 A1
(43) Pub. Date: May 19, 2016

(54) CAPTURE APPARATUSES OF VIDEO IMAGES

(71) Applicant: Quanta Computer Inc., Taoyuan City (TW)

(72) Inventors: Wei-Min CHAO, Taoyuan City (TW); Hsin-Yu CHEN, Taoyuan City (TW); Chia-Hsiang CHEN, Taoyuan City (TW)

(21) Appl. No.: 14/692,188

(22) Filed: Apr. 21, 2015

(30) Foreign Application Priority Data
Nov. 17, 2014 (TW) 103139704

(51) Int. Cl. H04N 5/232; H04N 5/235; H04N 5/225

(52) U.S. Cl. CPC H04N 5/23245; H04N 5/2258; H04N 5/235

(57) ABSTRACT

A capture apparatus of video image is provided with image sensors and an image composer. Each image sensor continually captures plurality sets of video image data, wherein each set of video image data includes odd frame image data and even frame image data and the images sensors includes a first set of image sensors and a second set of image sensors. The image composer is coupled to the image sensors and is configured to filter the odd frame image data from the video image data of the first set of image sensors and the even frame image data from the video image data of the second set of image sensors, compose the odd frame image data and/or the even frame image data to generate an output image with a fixed output resolution according to an input resolution of the video image data and the fixed output resolution.

### CROSS REFERENCE TO RELATED APPLICATIONS

This Application claims priority of Taiwan Application No. 103139704, filed on Nov. 17, 2014, and the entirety of which is incorporated by reference herein.

### BACKGROUND OF THE INVENTION

1. Field of the Invention

The invention generally relates to image capture apparatuses and related image processing methods, and more particularly, to capture apparatuses of video images and image processing methods thereof capable of simultaneously capturing multiple video images.

2. Description of the Related Art

Due to the popularity of Internet applications in recent years, using video conferencing for communication has become a trend. Video conferencing allows two or more people to instantly transfer text messages, files, audio messages and videos through the Internet. With the video conferencing, multiple users can transmit video and/or audio messages to each other for conference through a webcam and microphone device.

With the video call applications reaching maturity, users' demand switched from one-by-one video calls to one-to-many group video calls. In order to allow remote users to clearly understand what a proximal speaker wants to express, there is often a need to share electronic documents information, how to use a certain program, the demonstrated operating steps of specific instruments and equipment, the site situation spotted by the illustrator, or a combination of the above to the user group engaged in the call. Therefore, instantly sending multiple videos and display screens to each caller is a pressing issue.

However, in a conference room where a video conferencing with multiple users is being performed, large network bandwidth consumption may be caused when each user has their own computer device for video conferencing. Additionally, the camera on each user's computer device can only have a single angle of display. Thus, remote users may not fully acquire the entire scenes and statuses during the video conferencing.

### BRIEF SUMMARY OF THE INVENTION

Accordingly, embodiments of the invention provide capture apparatuses of video images and image processing methods thereof capable of simultaneously capturing multiple video images.

In one aspect of the invention, a capture apparatus of video image is provided with a plurality of image sensors and an image composer. Each image sensor continually captures plurality sets of video image data, wherein each set of video image data includes an odd frame image data and an even frame image data and the images sensors includes a first set of image sensors and a second set of image sensors. The image composer is coupled to the image sensors and is configured to filter the odd frame image data from the video image data of the first set of image sensors and the even frame image data from the video image data of the second set of image sensors, compose the odd frame image data and/or the even frame image data to generate an output image with a fixed output resolution according to an input resolution of the video image data and the fixed output resolution.

In another aspect of the invention, a processing method of video images is provided. The method comprises the following steps. First, a plurality of image sensors are configured to continually captures plurality sets of video image data, wherein each set of video image data includes an odd frame image data and an even frame image data and the images sensors includes a first set of image sensors and a second set of image sensors. Then, an image composer is configured to filter the odd frame image data from the video image data of the first set of image sensors and the even frame image data from the video image data of the second set of image sensors. Thereafter, the odd frame image data and/or the even frame image data are composed by the image composer to generate an output image with a fixed output resolution according to an input resolution of the video image data and the fixed output resolution.

Image processing methods may be practiced by the disclosed apparatuses or systems which are suitable firmware or hardware components capable of performing specific functions. Image processing methods may also take the form of a program code embodied in a tangible media. When the program code is loaded into and executed by a machine, the machine becomes an apparatus for practicing the disclosed method.

### BRIEF DESCRIPTION OF DRAWINGS

The invention can be more fully understood by reading the subsequent detailed description and examples with references made to the accompanying drawings, wherein:

FIG. 1 is a schematic diagram illustrating an embodiment of a capture apparatus of video images of the invention;

FIG. 2 is a schematic diagram illustrating a configuration of the image sensors according to an embodiment of the invention;

FIG. 3 is a schematic diagram illustrating an embodiment of video image data of the invention;

FIG. 4 is a schematic diagram illustrating an embodiment of detail circuits of a capture apparatus of video image of the invention;

FIG. 5 is a flow chart illustrating an image processing method according to an embodiment of the invention;

FIGS. 6A to 6C are schematic diagrams illustrating embodiments of the image processing sequences of different output modes of the invention; and

FIGS. 7A to 7C are schematic diagrams illustrating embodiments of the output images of the invention corresponding to the output modes as shown in FIGS. 6A to 6C, respectively.

### DETAILED DESCRIPTION OF THE INVENTION

The following description is of the best-contemplated mode of carrying out the invention. This description is made for the purpose of illustrating the general principles of the invention and should not be taken in a limiting sense.

Embodiments of the invention provide capture apparatuses of video images and related image processing methods thereof, which can use multiple image sensors arranged and pointed in different directions to capture images. Multiple images captured by respective image sensors can be composed into one large output image through a unique data selection circuit and one line storage unit, without requiring extra storage memory for storing the image data captured. The composed large output image can then be compressed through video compression and connected to a host device through the connection interface, such as a universal serial bus (USB) interface, so as to achieve the image composition online, thus effectively reducing costs and maintaining high quality.

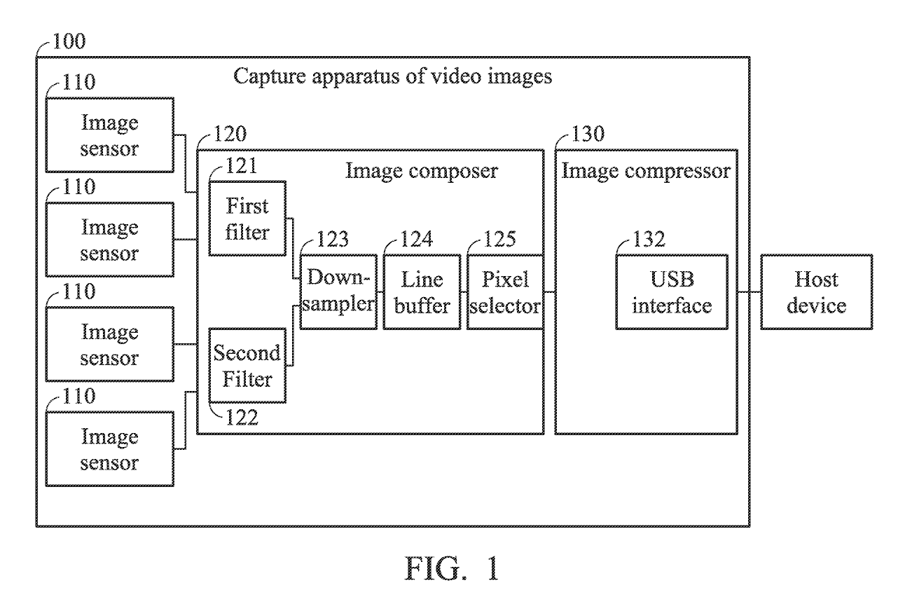

FIG. 1 is a schematic diagram illustrating an embodiment of a capture apparatus of video images of the invention. The capture apparatus of video images 100 of the invention can be serve as a web cam, a TV cam and so on, however, it is to be understood that the invention is not limited thereto. As shown in FIG. 1, the capture apparatus of video images 100 at least comprises multiple image sensors 110, an image composer 120 and an image compressor 130. It is to be understood that the image sensors 110, the image composer 120 and the image compressor 130 can respectively comprise suitable hardware circuits and software program codes to complete respective operations.

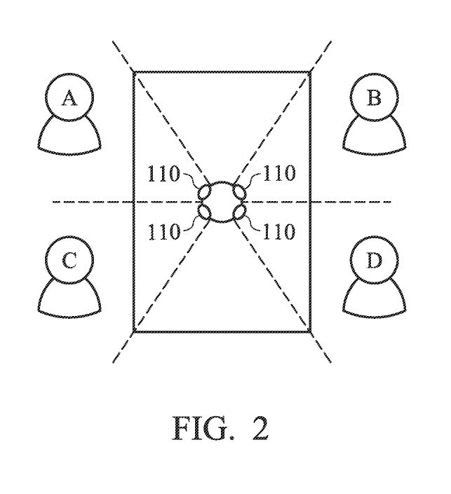

In some embodiments, the image sensors 110 are configured in different directions to capture video image data in the corresponding directions. For example, assuming that the capture apparatus of video images 100 has four image sensors, the image sensors can be set up in four different directions to capture video images of meeting attendants in four directions, as shown in FIG. 2. The capture apparatus of video images 100 can be regarded as the image capture device, such as the webcam or TV cam, of the host device. The host device can be an electronic device, such as a computer system, a TV, a PDA (Personal Digital Assistant), a smartphone, a mobile phone, an MID (Mobile Internet Device, MID), a laptop computer, a car computer, a digital camera, a multi-media player, a game device, or any other type of mobile computational device, however, it is to be understood that the invention is not limited thereto.

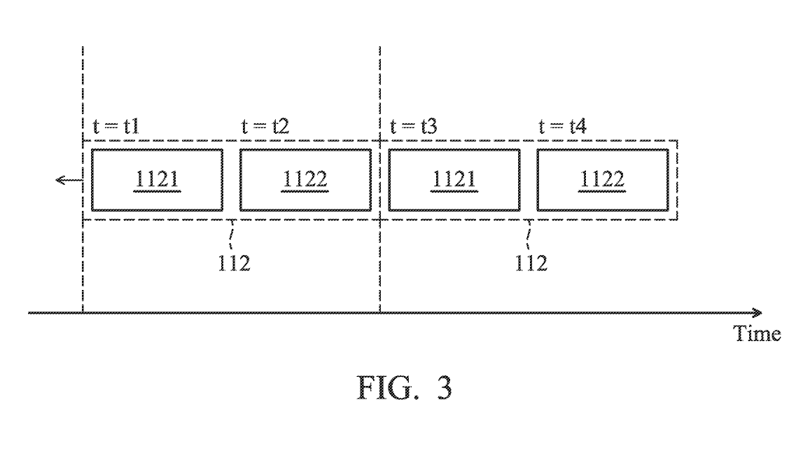

Each image sensor 110 can be used to continuously capture multiple sets of video image data, wherein each set of video image data contains odd frame image data and even frame image data. FIG. 3 shows a schematic diagram illustrating an embodiment of video image data of the invention. As shown in FIG. 3, the image sensors 110 can continuously capture multiple sets of video image data 112. In particular, the different sets of video image data 112 can be divided into odd frame image data 1121 and even frame image data 1122 based on the sequence of time received. Specifically, the image sensors 110 can continuously capture video image data within time t1 to t4, wherein the video image data of time t1 and the video image data of t3 can be regarded as odd frame image data. On the other hand, the video image data of t2 and the video image data of t4 can be regarded as even frame image data. In the embodiments, to conveniently explain it, one of odd frame image data and one of even frame image data are regarded as one set of video image data 112. In other words, the video image data of time t1 and that of time t2 are regarded as one set of video image data 112; and the video image data of time t3 and that of time t4 are regarded as another set of video image data 112. Therefore, one set of video image data 112 may include odd frame image data 1121 and even frame image data 1122.

The image composer 120 which is coupled to all of the image sensors 110 can perform the image processing method of the present invention, which will be discussed further in the following paragraphs. To be more specific, the image composer 120 can be used to separately filter odd frame image data from video image data of some of the image sensors and even frame image data from video image data of remaining image sensors, and then, based on the video image data input resolution and output resolution, composes the odd frame image data and the even frame image data into an output image with the output resolution in response to a mode selection signal. In particular, the mode selection signal is used to indicate the output mode of the output image. In some embodiments, the host device end user may input a selected output mode through a user interface or one input unit to generate the mode selection signal. In this embodiment, the output mode of the output image can include at least a first mode, a second mode, and a third mode, wherein the output images generated by different output mode also vary. To be more specific, when the first mode is selected, the output images are odd frame image data and/or even frame image data composed in all the image sensors. When the second mode is selected, the output images are odd frame image data and/or even frame image data composed from one selected image sensor. When the third mode is selected, the output images are odd frame image data or even frame image data selected directly from one image sensor. For example, assuming that the capture apparatus of video images 100 has four image sensors, when the output mode indicated by the mode selection signal is the first mode, the output image can be generated by composing odd frame image data and/or even frame image data from four image sensors; when the output mode indicated by the mode selection signal is the second mode, the output image can the output image can be generated by composing any two of the odd frame image data and/or even frame image data from the four image sensors; and when the output mode indicated by the mode selection signal is the third mode, the output image can be generated by directly selecting an odd frame image data or an even frame image data generated from one of the four image sensors. Thereafter, the image composer 120 may transmit the output image generated to the video compressor 130.

The video compressor 130 which is coupled to the image composer 120 can compress the output images into compressed video signals based on one video compression standard (such as H.264, MPEG2 etc.), which are delivered and displayed on the host device. Specifically, the video compressor 130 may further include a USB interface 132, through which compressed video signals are transmitted and displayed on the host device.

The image composer 120 may further include a first filter 121 and a second filter 122, which are used to filter odd frame image data of the first set of image sensors and even frame image data from the second set of image sensors, respectively. The image composer 120 may further include a down-sampler 123, which is coupled to the first filter 121 and the second filter 122 and is used for selectively downsampling the odd frame image data and/or even frame image data based on the input resolution of the video images, the output resolution of the output image, and the output mode indicated by the mode selection signal and generating the output images subsequently based on the down-sampled even frame image data and/or odd frame image data.

In particular, the down-sampler 123, in response to the mode selection signal, downsampling the odd frame image data and/or even frame image data when the input resolution is equivalent to the output resolution. For example, when the input resolution is equivalent to the output resolution and the mode selection signal falls under the aforementioned first mode or second mode, it means the output image is made up of the video images captured by a number of image sensors 110. Thus, the video images captured can only be composed into the output image after the downsampling.

The image composer 120 may further include a line buffer 124 used to temporarily store odd frame image data and/or even frame image data required for the composing of output image. In particular, the line buffer 124 can be used to store image data with a length that is the length of the width of one line of the screen.

The image composer 120 may further include a pixel selector 125 used to select one of the multiple output modes to compose the filtered odd frame image data and/or odd frame image data into the output image with the output resolution based on the mode indicated by the mode selection signal.

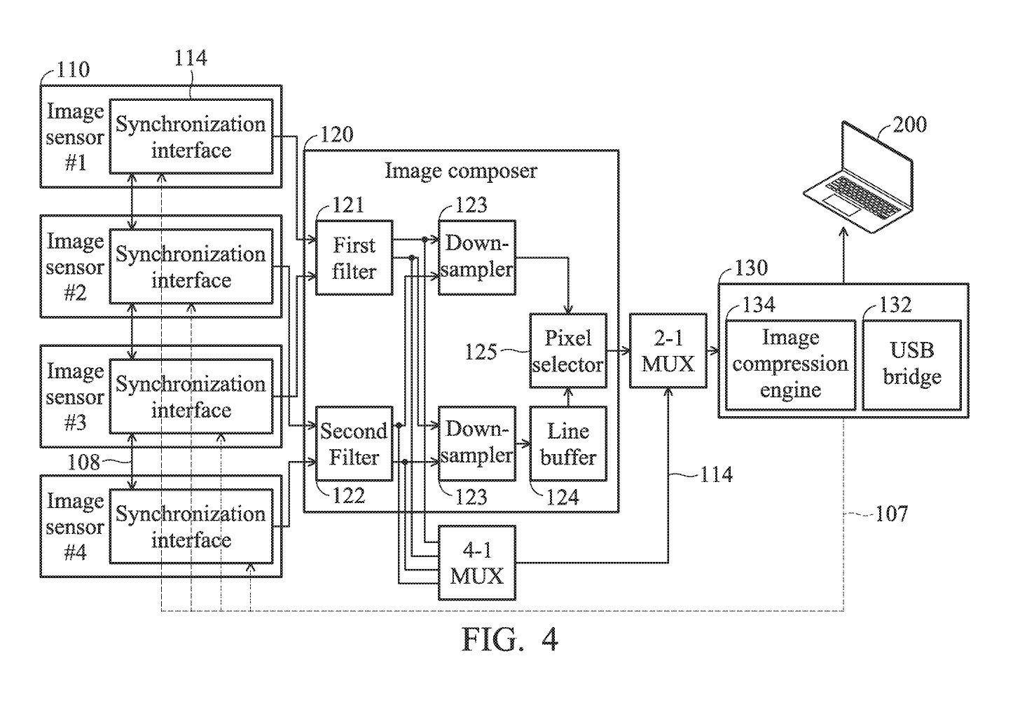

FIG. 4 is a schematic diagram illustrating an embodiment of detail circuits of a capture apparatus of video images of the invention. It is to be understood that, for illustration, four image sensors are used in this embodiment, however, it is to be understood that the invention is not limited thereto. It is also applicable to other quantities of image sensors. As shown in FIG. 4, each image sensor 100 has a synchronization interface 114. In particular, the synchronization interfaced 114 of all the image sensors 110 are connected together to synchronize between all image sensors 110. Through the synchronization interfaces of the image sensors 110, the timing sequence of all the images captured by all image sensors can be synchronized, so as to correctly filter the odd frame image data and even frame image data. Each respective image sensor 110 is used to convert photons into electronic signals. In particular, each image sensor 110 may have the output capability of more than 60 frames per second and image output synchronization capability, which may further include four image processing sequences used to convert the original electrons into pixel data with YUV colors. The image composer 120 includes the above-mentioned the first filter 121 (also be referred to as odd frame filter), which can filter the odd frame image data, the second filter 122 (also be referred to as even frame filter), which can filter even frame image data, the down-sampler 123 and the line buffer 124 that have the length of one line of a screen, and the pixel selector 125. In particular, the first filter 121 and the second filter 122 are separately connected to the down-sampler 123, the down-sampler 123 is further connected to the line buffer 124 and the pixel selector 125 is further connected after the line buffer 124 and another down-sampler 123. The radical path 214 is used to select one of the images from the four image sensors, and the pixels sampling must not be reduced. In other words, the down-sampler 123 can be used to reduce the pixel sampling of the screen, wherein the downsampling method is to sample one point for every two horizontal and adjacent pixel points and to sample one point for every two vertical and adjacent pixel points. The pixel selector 125 can be used to select pixel points on the left or right screen or output black pixels (mask pixels), thereby generating the desired output images. The video compressor 130 is connected next to the image composer 120, which includes a USB bridge 132 and an image compression engine 134, of which the image compression engine 134 has the video compression capability of JPEG, H.264, and VP8 format. The USB bridge 132 on the other hand can output two video streams: one in JPEG or YUV format; the other in H.264 or VP8 format. The video compression signals compressed by the video compressor 130 are sent to a computer device or embedded system 200 with capability of receiving USB videos through the USB bridge 132. Additionally, the sequence control signal line 107 can set and read the status of four image sensors in sequence. The details of the unit operations will not be elaborated since they are mentioned earlier.

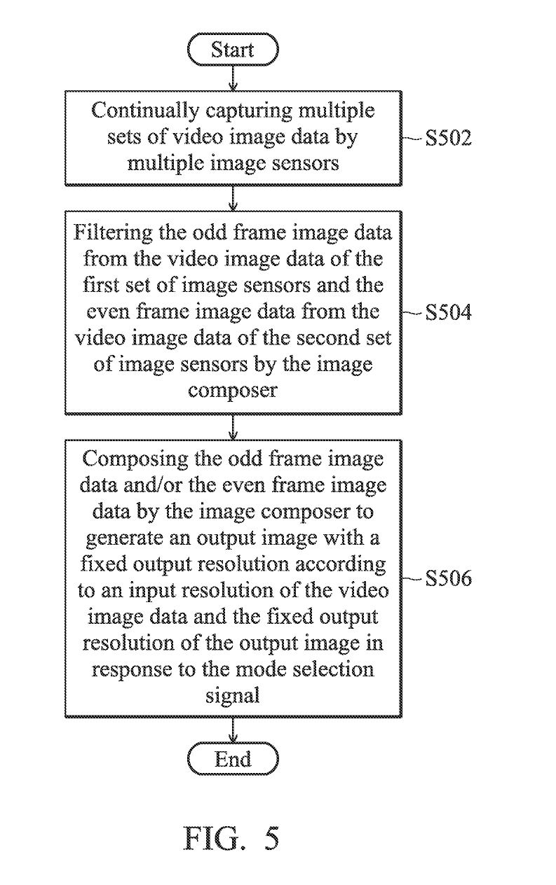

FIG. 5 is a flow chart illustrating an image processing method according to an embodiment of the invention. The image processing method can be applied to an image capture apparatus such as the capture apparatus of video images 100 of FIG. 1.

First, in step S502, multiple sets of video image data are continuously captured by the image sensors 110. In particular, each set of video image data includes odd frame image data and even frame image data. Moreover, the image sensors 110 can include first set of image sensors and second set of image sensors. Then, in step S504, odd frame image data from the video image data of the first set of image sensors and the even frame image data from the video image data of the second set of image sensors are filtered through the image composer 120. Thereafter, in step S506, through the image composer 120 and based on the input resolution of the video image data and the output resolution of the output image, the odd frame image data and even frame image data are composed into an output image with an output resolution in response to a mode selection signal. Specifically, the mode selection signal is used to indicate the output mode of the output image.

For explanation, image processing methods are illustrated as examples in the following embodiments, and those skilled in the art will understand that the present invention is not limited thereto. In the following embodiments, assuming that the capture apparatus of video images 100 has four image sensors directed at four different directions for allowing users from the four directions and a computer device in the remote end to engage in video conferencing at the same time, and then it is connected to the computer device through a connection interface, such as the USB interface to be regarded as an image capture device of the computer device.

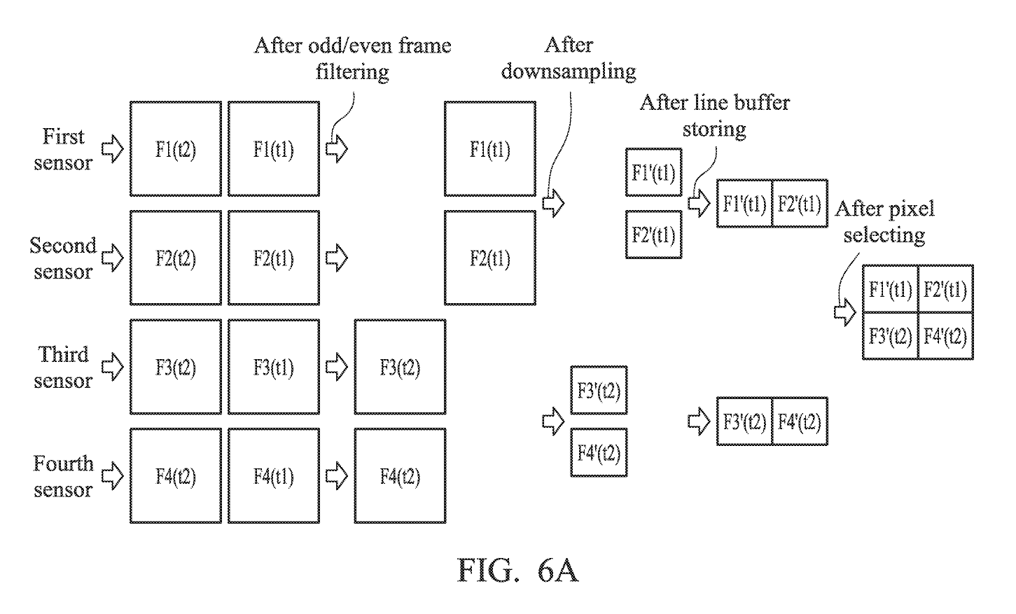

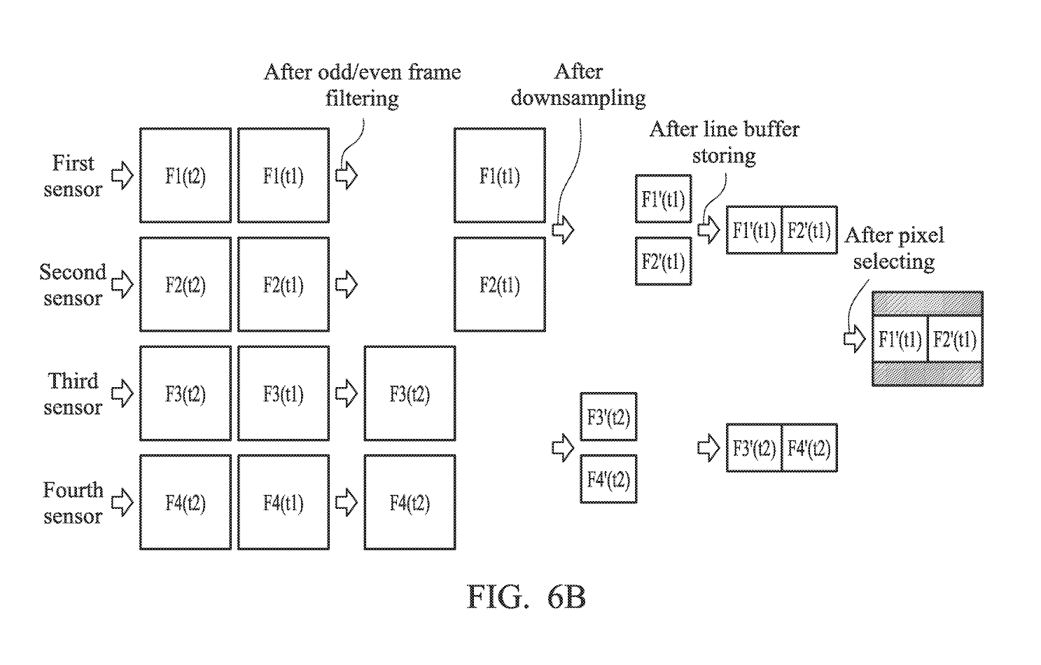

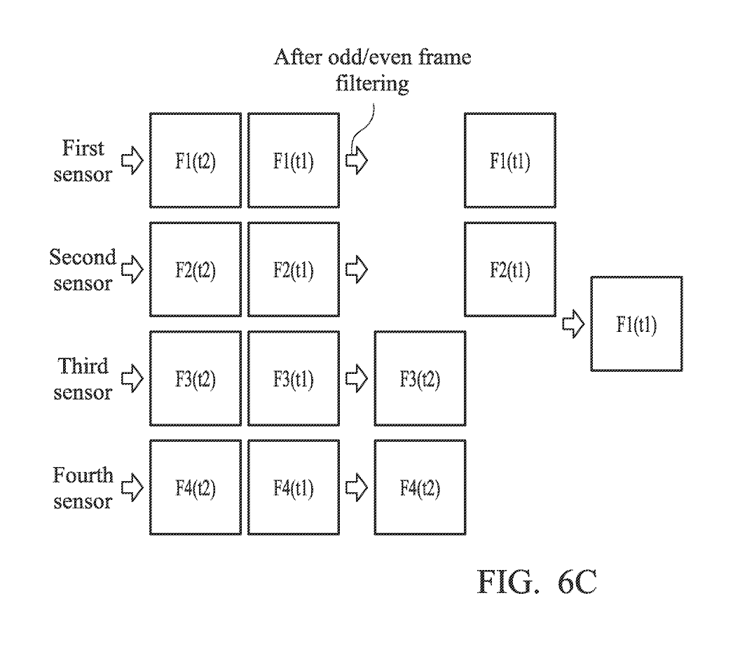

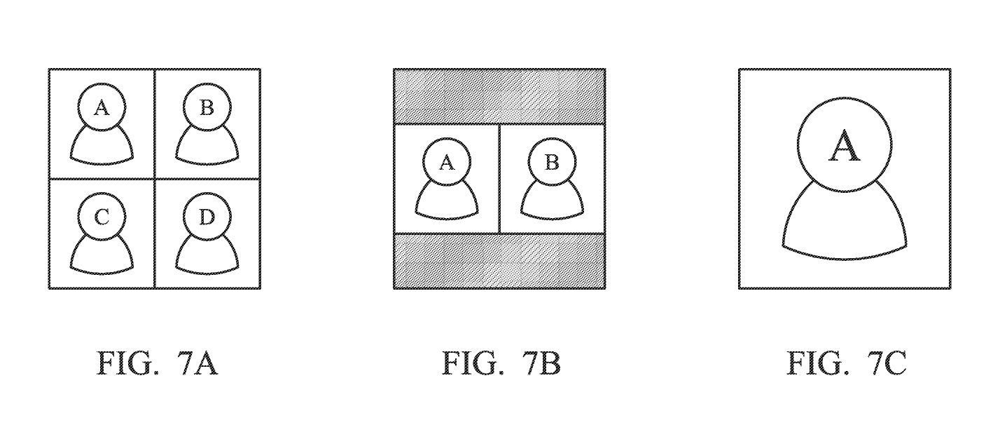

FIGS. 6A to 6C are schematic diagrams illustrating embodiments of the image processing sequences of different output modes of the invention. Note that, F1(t1) and F1(t2) respectively represent the odd frame image data captured at time t1 and the even frame image data captured at time t2 by the first sensor. F2(t1) and F2(t2) respectively represent the odd frame image data captured at time t1 and the even frame image data captured at time t2 by the second sensor. F3(t1) and F3(t2) respectively represent the odd frame image data at time t1 and the even frame image data captured at time t2 by the third sensor. F4(t1) and F4(t2) respectively represent the odd frame image data captured at time t1 and the even frame image data captured at time t2 by the fourth sensor and so forth. FIGS. 7A to 7C are schematic diagrams illustrating embodiments of the output images of the invention corresponding to the output modes as shown in FIGS. 6A to 6C, respectively. As shown in FIG. 7A, since the output mode displayed in FIG. 6A is the first mode, the output image of the output mode corresponding to FIG. 6A include the composed image of the first, second, third, and fourth sensor images, wherein, the representative images of the first and second sensor are odd frame image data, while the representative images of the third and fourth image sensors are even frame image data. In one embodiment, when the input resolutions of the video image data of the respective image sensors are 360P and 60 fps, and the output resolutions of the output images are 720P and 30 fps, the four images, which are the odd and even frame image data filtered from the respective image sensors, can be directly composed into one output image without requiring the downsampling through the down-sampler. In another implementation example, when the input resolutions of the video image data of the respective image sensors are 720P and 60 fps, and the output resolutions of the output images are 720P and 30 fps, the four images, which are the odd or even frame image data filtered from the respective image sensors, need to perform the downsampling through the down-sampler first and then the downsampled four images can be composed into an output image.

FIG. 6A shows the image processing sequence when the first mode is the output mode. As shown in FIG. 6A, the first, second, third, and fourth image sensors are used to continuously capture multiple sets of video image data: (F1(t1) and F1(t2)), (F2(t1) and F2(t2)), (F3(t1) and F3(t2)), and (F4(t1) and F4(t2). Then, the first set of image sensors (the first and second image sensors) filter odd frame image data F1(t1) and F2(t1) through the first filter, while the second set of image sensors (the third and fourth image sensors) filter even frame image data F3(t2) and F4(t2) through the second filter. In this embodiment, the filtered odd frame image data F1(t1) and F2(t1) and even frame image data F3(t2) and F4(t2) are downsampled through the down sampler to generate down-sampled odd frame image data F1′(t1) and F2′(t1) and even frame image data F3′(t2) and F4′(t2). Subsequently, the F1′(t1) and F2′(t1) first outputted from the down-sampled odd frame image data F1′(t1) and F2′(t1) and the down-sampled even frame image data F3′(t2) and F4′(t2) are temporarily stored in the line buffer, and F3′(t2) and F4′(t2) outputted later and the stored F1′(t1) and F2′(t1) are then to be composed such that four images, F1′(t1), F2′(t1), F3′(t2), and F4′(t2), are composed into one output image based on the first mode selected by the pixel selector, as shown in FIG. 7A.

FIG. 6B shows the image processing sequence when the second mode is the output mode. The image processing sequence as shown in FIG. 6B is similar to that in FIG. 6A, except that: when image composition has performed by the pixel selector, as the second mode selected only requires two images from the four image sensors to be used, the pixel selector may only use the two images selected, such as F1′(t1) and F2′(t1), to compose into the output image. It is to be noted that, in the second mode, the screen of composed output image may output black images to fill the white spaces to give the screen a better appearance, as shown in FIG. 7B.

FIG. 6C shows the image processing sequence when the third mode is the output mode. The image processing sequence as shown in FIG. 6C is similar to that in FIG. 6A and FIG. 6B. The difference is that, after the first set of image sensors (the first and second image sensors) filter the odd frame image data F1(t1) and F2(t1) through the first filter and the second set of image sensors (the third and fourth image sensors) filter the even frame image data F3(t2) and F4(t2) through the second filter, the pixel selector may, through the third mode selected, regard one of the four images F1(t1), F2(t1), F3(t2), and F4(t2) designed as the output image without requiring the downsampling, as shown in FIG. 7C.

Therefore, the capture apparatus of video images and related image processing methods of the invention can utilize the output capability of the image composer and the synchronization capability between all of the image sensors to design a unique data selection circuit and one line storage unit so as to achieve online composition without requiring extra storage spaces to store image data, thereby effectively reducing costs and maintaining the high quality of transmitted images.

Systems and method thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A capture apparatus of video image, comprising:
a plurality of image sensors, continually capturing plurality sets of video image data, wherein each set of video image data comprises an odd frame image data and an even frame image data and the images sensors comprises a first set of image sensors and a second set of image sensors; and
an image composer coupled to the image sensors, respectively filtering the odd frame image data from the set of video image data of the first set of image sensors and the even frame image data from the set of video image data of the second set of image sensors and composing the odd frame image data and/or the even frame image data to generate an output image with a fixed output resolution according to an input resolution of the set of video image data and the fixed output resolution in response to a mode selection signal,
wherein the mode selection signal indicates an output mode of the output image.

2. The capture apparatus of video image of claim 1, further comprising a video compressor for compressing the output image to compressed video signals to transmit to a host device for displaying according to a video compression standard.

3. The capture apparatus of video image of claim 2, wherein the video compressor further comprises a USB interface, wherein the compressed video signals are transmitted to the host device for displaying through the USB interface.

4. The capture apparatus of video image of claim 1, wherein the image composer further comprises:
first and second filters for filtering out the odd frame image data from the set of video image data of the first set of image sensors and the even frame image data from the set of video image data of the second set of image sensors, respectively; and
a down-sampler coupled to the first and second filters, selectively down-sampling the odd frame image data and/or the even frame image data according to the input resolution, the fixed output resolution and the mode selection signal, and generating the output image according to the down-sampled odd frame image data and/or even frame image data.

5. The capture apparatus of video image of claim 4, wherein the down-sampler further down-samples the odd frame image data and/or the even frame image data in response to the mode selection signal when the input resolution is equal to the fixed output resolution.

6. The capture apparatus of video image of claim 1, wherein the image composer further comprises a line buffer for temporarily storing the odd frame image data and/or the even frame image data required for the composition of the output image, wherein the line buffer is arranged for storing image data with a length that is equal to the length of the width for one line of the screen.

7. The capture apparatus of video image of claim 1, wherein each of the image sensors further comprises a synchronization interface and the synchronization interfaces of all of the image sensors are connected together for synchronization between all the image sensors.

8. The capture apparatus of video image of claim 1, wherein the image composer further comprises a pixel selector for selecting one of a plurality of output modes to compose the odd frame image data and/or the even frame image data to generate the output image with the fixed output resolution according to the mode selection signal.

9. The capture apparatus of video image of claim 8, wherein the output modes further comprises a first mode, a second mode and a third mode, and the pixel selector further selects the one of output modes which is indicated by the mode selection signal to compose the odd frame image data and/or the even frame image data to generate the output image with the fixed output resolution according to the mode selection signal, wherein:
when the mode selection signal indicates that the first mode has selected, the pixel selector composes the odd frame image data and/or the even frame image data of all of the image sensors to generate the output image with the fixed output resolution;
when the mode selection signal indicates that the second mode has selected, the pixel selector composes the odd frame image data and/or the even frame image data of a set of the image sensors selected to generate the output image with the fixed output resolution; and
when the mode selection signal indicates that the third mode has selected, the pixel selector directly utilizes the odd frame image data or the even frame image data of a set of the image sensors selected to generate the output image with the fixed output resolution.

10. The capture apparatus of video image of claim 1, wherein the image sensors are arranged in different directions for capturing the set of video image data at respective directions.
